(19) United States
(12) Patent Application Publication
(10) Pub. No.: US 2026/0359736 A1
(43) Pub. Date: Nov. 12, 2026

(54) Event Ticketing Management Systems and Methods

(71) Applicant: Timeless Tech LLC, Ocean, NJ (US)

(72) Inventor: Grant Rataski, Ocean, NJ (US)

(21) Appl. No.: 19/668,563

(22) Filed: May 5, 2026

Related U.S. Application Data
(63) Continuation of application No. 19/066,110, filed on Feb. 27, 2025, now abandoned.
(60) Provisional application No. 63/560,447, filed on Mar. 1, 2024.

(51) Int. Cl. G06Q 10/02; G06F 21/31

(52) U.S. Cl. CPC G06Q 10/02; G06F 21/31

(57) ABSTRACT

Embodiments of the disclosed systems and methods provide for an improved service-based system for managing event ticketing. Various embodiments leverage available artist preference information obtained from streaming and/or download content services to more effectively allocate tickets to certain targeted users and/or user groups. Further embodiments allow for the use of artist-specified criteria in connection with ticket distribution and/or allocation, providing artist's granular control of ticketing for their associated events. Among other things, embodiments disclosed herein may allow for artists to be compensated for ticket sales at specified ticket face values, while reducing the likelihood of bot interference and inflated secondary ticket markets associated with conventional electronic ticketing platforms.

### RELATED APPLICATION

This application is a continuation of U.S. application Ser. No. 19/066,110, filed Feb. 27, 2025, and entitled “Event Ticking Management Systems and Methods,” which claims the benefit of priority under 35 U.S.C. § 119(e) to U.S. Provisional Patent Application No. 63/560,447, filed Mar. 1, 2024, and entitled “Event Ticketing Management Systems and Methods,” both of which are hereby incorporated by reference in their entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing event ticketing. More specifically, but not exclusively, the present disclosure relates to event ticketing systems and methods that facilitate ticket allocation to users with an established interest in an artist, which may be verified and/or otherwise indicated by a content service.

Conventional ticketing platform services have adversely impacted the live event experience by imposing excessive fees, generating extended wait times and/or queues, and enabling the acquisition of tickets by automated bots, consequently leading to ticket resale at often significantly inflated prices. This has undermined the accessibility and experience of attending live events for many genuine fans and/or attendees seeking to enjoy performances by the favorite artists. Moreover, artists often do not realize any profits for tickets sold on the secondary market at prices inflated over face value. Efforts to address these challenges, such as artist-issued presale codes, remain susceptible to bot interference when executed through conventional ticketing services and/or channels.

Embodiments of the systems and methods provide an improved service-based system for managing event ticketing. Many users consume audio and/or video content from their favorite artists via content streaming and/or download services. These services, available in a diverse range, have emerged as primary channels for music consumption among consumers. As consumers interact with such services, certain analytics data may be captured by the services. This data may encompass information that indicates or can be utilized to infer an individual consumer's preferred artist(s). For instance, certain streaming services may track a user's most frequently listened-to artists, measured by metrics such as total hours listened, number of tracks played, number of albums accessed, among others. These services may further gather other data indicative of user artist preferences, which in some circumstances may be reflected in explicit indications of preferences furnished by a user to the service.

Embodiments of the disclosed systems and methods provide ticket management services that leverage available artist preference information obtained from content services (e.g., download and/or streaming content services) to more effectively allocate tickets to certain targeted users and/or user groups, potentially in accordance with requirements and/or criteria associated with and/or specified by artists. For example, in various embodiments, a ticket management service may receive insights into an artist's top fans from a music streaming service (e.g., the artist's top 5,000 fans as indicated by the streaming service). An artist may designate that a certain number of tickets for an event are to be allocated and offered by the ticket management service to the indicated top fans at face value. Using such a service, artists may continue to receive their standard face value profits from the ticket management service, but their most engaged fans may face fewer challenges commonly associated with conventional ticketing platforms and services, such as bot interference and inflated secondary ticket markets.

### BRIEF DESCRIPTION OF DRAWINGS

The inventive body of work will be readily understood by referring to the following detailed description in conjunction with the accompanying drawings, in which:

FIG. 1 illustrates a non-limiting example of a ticket management ecosystem consistent with certain embodiments of the present disclosure.

FIG. 2 illustrates a non-limiting example of a ticket management ecosystem implementing artist-specified ticket distribution criteria information consistent with certain embodiments of the present disclosure.

FIG. 3 illustrates a conceptual diagram of a ticket management process interaction consistent with certain embodiments of the present disclosure.

FIG. 4 illustrates a non-limiting example of a preferred artists interface of a ticket management service consistent with certain embodiments of the present disclosure.

FIG. 5 illustrates a non-limiting example of an artist event availability interface of a ticket management service consistent with certain embodiments of the present disclosure.

FIG. 6 illustrates a flow chart of a non-limiting example of a method for managing ticket distribution consistent with certain embodiments of the present disclosure.

FIG. 7 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein in certain instances, but not necessarily all instances, like parts may be designated by like numerals or descriptions. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods provide improved ticket management services that utilize accessible artist preference data acquired from content services to provide improved allocation of event tickets to specific targeted users and/or user groups. In various embodiments, a ticket management service may interact with a content service providing streaming and/or download services to receive information relating to an artist's top fans and/or user's top and/or otherwise preferred artist(s). This information may comprise, for example and without limitation, metrics relating to a user's most frequently listened-to artists (e.g., by total hours listened, total albums listened, total tracks played, and/or the like).

Consistent with embodiments disclosed herein, an artist may designate a certain number of tickets for an event to be allocated and offered by ticket management services directly to top fans at face value. The targeted top fans may be identified by the ticket management service based on the information accessed from a content service. In this manner, artists may maintain their standard face value profits from ticket sales, while their most dedicated fans may encounter fewer challenges purchasing tickets and attending events.

Various embodiments and associated examples are described herein in connection with music streaming services and ticketing services to associated music events. It will be appreciated, however, that embodiments of the disclosed systems and/or methods may be used in a variety of other contexts, use cases, and/or event ticketing paradigms. Indeed, various aspects of the disclosed systems and methods may be implemented in connection with ticketing services for a variety of other entertainment events including, for example and without limitation, movies, sporting events, community events, other live events, and/or the like.

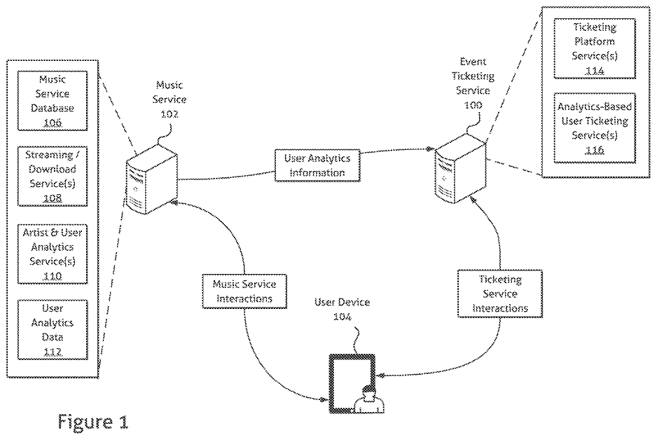

FIG. 1 illustrates a non-limiting example of a ticket management ecosystem consistent with certain embodiments of the present disclosure. As described in more detail below, the illustrated ecosystem may comprise one or more music service systems 102 (which may be generally referred to herein in certain instances as simply a music service), an event ticketing management service system 100 (which may be generally referred to herein in certain instances as simply an event ticketing management service, and event ticking management service, and/or derivatives of the same), and one or more user systems and/or devices 104. Although a single music service 102 and a single user device 104 is illustrated in the figure, it will be appreciated that in further embodiments, the event ticketing management service 100 may interface and/or otherwise communicate with multiple music services and/or user devices.

In various embodiments, the music service 102 and/or event ticketing management service 100 may comprise a variety of computing systems and/or platforms including, for example and without limitation, desktop computer systems, laptop computer systems, and/or enterprise platform computer systems, services, and/or associated systems. Similarly, the user system(s) and/or device(s) 104 may comprise a variety of suitable computing system and/or devices including, for example and without limitation, one or more desktop computer systems, laptop computer systems and/or other computing devices, tablet devices, smartphone devices, wearable devises such as a smartwatch, and/or the like.

As shown, a music service 102 may offer content included in a database 106 managed by the service 102 for streaming and/or download to various user devices. A user (via their device 104) may interact with streaming and/or download services 108 offered by the music service 102 using a music service application executing on the user device 104 (and/or other systems and/or devices associated with the user). Various analytics data 112 may be captured by artist and/or user analytics services 110 of the music service 106 as the user device interacts with the music service 102. This data 112 may be used to determine and/or otherwise infer a user's preferred artist(s) and/or to generate a threshold ranking of a user's listening frequency of a particular artist, genre, and/or the like relative to other service users listening habits.

In certain embodiments, captured analytics data 112 may be used to establish a preferred artist list and/or framework for a particular user, potentially based on metrics which may be set by the music service (e.g., listening frequency, duration, recency, and/or similar thresholds). For example and without limitation, based on captured analytics data 112, the music service 102 may determine a particular listener's top 10 most listened to artists, which may be reflected in analytics data 112 managed by the user and/or artist analytics service(s) 110 of the music service 102.

A variety of user analytics data 112 may be captured by a music service 102 as users interact with the service 102. This data 112 may include, for example and without limitation, information relating to a duration that a user listens to artist(s), a number of tracks of a particular artist listened to by a user, a user's most frequently listened-to artists, most requested and/or searched artist(s), most recently listened-to artists, metrics such as total hours listened, number of tracks played, number of albums accessed, user purchase history, and/or the like. In further embodiments, users may provide the music service 102 with explicit indication(s) of artist preferences, which may be included in analytics data captured by the artist and/or user analytics service(s) 110 of the music service.

Consistent with embodiments disclosed herein, the music service 102 may share user analytics information 112 and/or information derived therefrom with an event ticketing management service 100. In certain embodiments, the analytics information 112 may be accessed by the event ticketing management service 100 via an application programming interface (“API”) exposed by the music service 102. In some implementations, raw analytics information (e.g., number of listening hours, number of tracks listened to, etc.) may be obtained from the music service 102 by the event ticketing management service 100. In further embodiments, analytics information shared by the music service 102 may be structured and/or be indicative of inferences relating to artist preferences drawn by the artist and/or user analytics service(s) 110 of the music service 102. For example and without limitation, in some embodiments, the event ticketing management service 100 may access an API of the music service 102 to receive a listing of the top 5,000 (or some other suitable number) of fans of a particular artist as determined by the music service 102.

In various embodiments, an artist may designate a certain number of tickets for an event to be allocated and offered by the event ticket service 100 directly to a certain subset of users at face value. For example and without limitation, when offering an event for sale through the event ticketing management service 100, an artist may designate that 1,000 tickets (or some other desired number) should be offered to its top fans as designated by user analytics information received from a music service 102 (or multiple music services). In some embodiments, criteria for this allocation may be communicated by a system associated with the artists to the event ticketing management service 100 (not shown). Ticketing platform services 114 of the event ticketing management service 100 may interface with analytics-based user ticketing services 116 to enforce such an allocation in accordance with the artist-specified criteria when offering tickets for sale.

In certain embodiments, criteria specified by artists for special ticket allocations and/or user analytics information may be geographically bounded. For example and without limitation, in some embodiments, criteria specified by artists may allocate tickets to their top 1,000 fans in a geographic area surrounding an event venue as indicated by user analytics data with associated geographic parameters. In further embodiments, no associated geographic limitations may be specified by an artist and/or reflected in user analytics data 112.

A user may interact with the event ticketing management service 100 via a ticketing service application executing on their user system and/or device 104 to browse upcoming events and/or purchase tickets. Consistent with embodiments disclosed herein, if a user meets criteria specified by an artist for a special ticket allocation based on user analytics information received from the music service 102, they may be presented with the ability to select and purchase tickets subject to this targeted ticket allocation. In this manner, artists may maintain their standard face value profits from ticket sales, while their most dedicated fans may encounter fewer challenges purchasing tickets and attending their events.

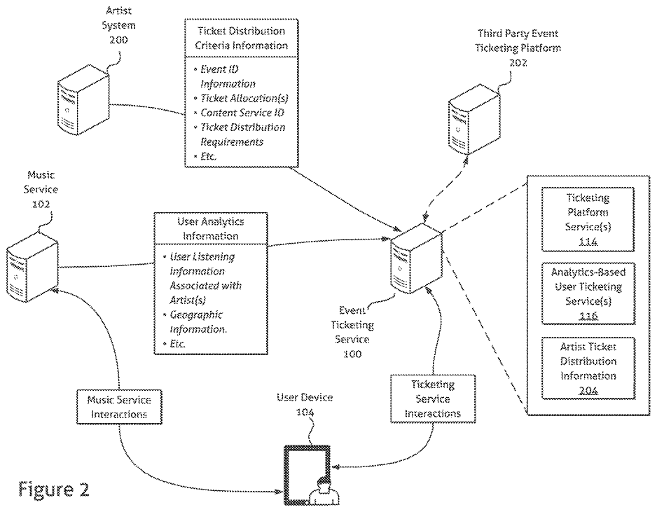

FIG. 2 illustrates a non-limiting example of a ticket management ecosystem implementing artist-specified ticket distribution criteria information consistent with certain embodiments of the present disclosure. In various disclosed embodiments, artist-specified criteria may be used in connection with the disclosed ticket distribution and/or allocation methods, providing artists relatively granular control of ticketing for their associated events in accordance with specified criteria.

As shown in the figure, an artist system (and/or an associated device) 200 may interact with the event ticketing management service 100 to provide various ticket distribution criteria information for use in connection with ticket allocation, distribution, and/or management operations consistent with aspects of the disclosed embodiments. The ticket distribution criteria information may specify a variety of information, including certain requirements relating to the management, allocation, and/or distribution of tickets for a particular artist event by the event ticking service 100. Consistent with embodiments disclosed herein, ticket distribution criteria information provided by an artist system 200 and/or associated requirements may be stored in a database and/or other suitable information store 204 and enforced by the event ticketing management service 100 and/or analytics-based user ticketing services 116 implemented by the same.

Ticket distribution criteria information may comprise various event identification information. Event identification information may comprise, for example and without limitation, associated artist identification information, event location and/or venue information, event time and/or date information, and/or other descriptive information relating to an event.

In certain embodiments, ticket distribution criteria information specified by artists may comprise various ticket allocation information for tickets to be distributed by the event ticketing management service 100. Ticket allocation information may comprise a variety of information and/or requirements relating to the allocation of tickets to and/or distribution of tickets by the event ticketing management service 100. In some embodiments, the ticket allocation information may, for example and without limitation, comprise a total number of tickets allocated for distribution by the event ticketing management service 100 by the artist, a number of tickets allocated to each user for purchase via the event ticketing management service 100 (e.g., a limited number of tickets specifically allocated to a user, a number available to a user for purchase from the total allocation until the total allocation has been exhausted, etc.), and/or the like.

In some embodiments, the event ticketing management service 100 implementing various aspects of the disclosed systems and methods may interact with one or more conventional third-party ticketing platforms and/or services 202 in connection with various ticketing allocation, management, and/or distribution processes. For example, in some embodiments, primary ticketing services for an event may be handled by a conventional third-party ticketing platform and/or service 202, with a special allocated distribution of tickets by the event ticketing management service 100 in accordance with artist-specified ticket distribution criteria consistent with aspects of the disclosed systems and methods. In the above manner, in some embodiments, the event ticketing management service 100 may interact with the third-party ticketing platform and/or services 202 in connection with receiving a special allocation of tickets for distribution by the service 100 (potentially along with other ticket distribution criteria information disclosed herein) and implementing the distribution of the specially-allocated tickets in accordance with associated artist-specified criteria.

In certain embodiments, the event ticketing management service 100 may leverage the third-party ticketing platform and/or services 202 in connection with various aspects of ticket distribution and/or purchasing. For example, the event ticketing management service 100 may implement distribution of tickets in accordance with artist-specified criteria consistent with embodiments disclosed herein, but may rely on services offered by the third-party ticketing platform and/or services 202 in connection with facilitating ticket payment and/or other aspects of the distribution of tickets such as, for example and without limitation, emailing and/or electronically sending ticket stubs, integrating ticket services with venues, and/or the like.

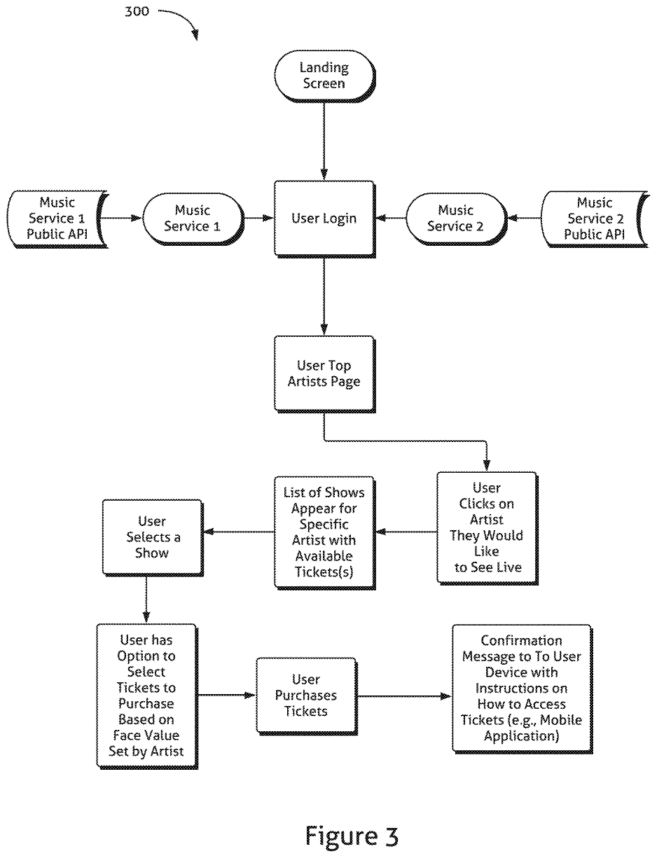

Although the artist system 200 is illustrated as interacting with the event ticketing management service 100 directly in connection with provisioning the service 100 with artist-specified ticket distribution criteria, it will be appreciated that in other implementations, all and/or a subset of this information may be provided to the third-party ticketing platform and/or services 202, which in turn may provide the received criteria information and/or relevant subsets of the same to the event ticketing management service 100 for use in connection with implementing the disclosed embodiments. In this manner, the third-party ticketing platforms and/or services 202 may act as an intermediary service, leveraging the functionality of the event ticketing management service 100 in connection with the distribution of specially allocated tickets responsive to artist-specified criteria. Therefore, it will be appreciated that the specific configuration of services and/or systems illustrated in FIG. 3 (and indeed, the other figures included herein) are illustrative of non-limiting examples of the disclosed embodiments, and that other configurations are possible without departing from the inventive concepts detailed herein.

Ticket distribution criteria information may further comprise information identifying one or more content services (e.g., content service identifiers). For example, the ticket distribution criteria information may identify one or more music streaming and/or download platform and/or services. In some embodiments, this information may comprise information identifying an address, API access information, and/or other access information that may be used by the event ticketing management service 100 to communicate with the identified content service(s) 102 and receive various user analytics information consistent with the disclosed embodiments.

Consistent with embodiments disclosed herein, the ticket distribution criteria information may comprise requirements relating to the management, allocation, and/or distribution of tickets to the event to be enforced by the event ticketing management service 100. For example and without limitation, in some embodiments, the ticket distribution criteria information may specify a threshold ranking associated with a user for the user to be eligible to receive a special ticket allocation and/or offer consistent with the disclosed embodiments. For example and without limitation, when offering an event for sale through the event ticketing management service 100, an artist may designate that 1,000 tickets (or some other desired number) should be offered to its 1,000 fans (or some other desired number) as designated by user analytics information received from a music service 102 (or multiple music services). This information may thus be reflected in the ticket distribution criteria information communicated from the artist system 200 to be enforced by the event ticketing management service 100. It will be appreciated that such threshold criteria information may vary in different implementations, use cases, and/or contexts, and may be reflective of threshold levels of user listening frequency, duration, recency, and/or the like. Moreover, it will be appreciated that certain embodiments may not use ranking and/or other comparatively determining information in connection with threshold criteria information relative to other users, instead relying on more user specific and/or granular information associated with a user's listening habits.

Requirements articulated in ticket distribution criteria information may further be geographic based. For example and without limitation, in some embodiments, ticket distribution criteria information specified by artists may allocate tickets to their top fans in a particular geographic area (e.g., a radius surrounding an event venue, a city, state, province, or region in which a venue is located, etc.). The event ticketing management service 100 may enforce such geographic requirements when distributing and/or allocating tickets to users, potentially accessing geographic information from other services in connection with such enforcement.

In further embodiments, artists may specify certain ticket pricing information within ticket distribution criteria information communicated to the event ticketing management service 100. For example and without limitation, an artist may designate that tickets allocated for distribution by the event ticketing management service 100 be sold at a specified face value price. In further embodiments, an artist may designate that tickets allocated for distribution by the event ticketing management service 100 be solid at a specified discounted price and/or rate from face value.

It will be appreciated that the ticket distribution criteria information specified by artists may include a wide variety of information and/or associated artist specified-requirements. Therefore, it will be appreciated that the various non-limiting examples of ticket distribution criteria are provided for purposes of illustration and explanation, and that ticket distribution criteria information may include less and/or additional information than the specified examples within the scope of the disclosed embodiments.

In various embodiments, an artist may designate a certain number of tickets for an event to be allocated and offered by the even ticket management service 100 directly to a certain subset of users at face value. For example and without limitation, when offering an event for sale through the event ticketing management service 100, an artist may designate that 1,000 tickets (or some other desired number) should be offered to its top fans as designated by user analytics information received from a music service 102 (or multiple music services).

Ticketing platform services 114 of the event ticketing management service 100 may interface with analytics-based user ticketing services 116 to enforce such an allocation in accordance with the artist-specified criteria when offering tickets for sale.

FIG. 3 illustrates a conceptual diagram of a ticket management process 300 interaction consistent with certain embodiments of the present disclosure. In certain embodiments, the process and/or aspects thereof may be performed by an event ticketing management service system, a music service system, and/or a user device, and/or by constituent services executing on such systems and/or devices. It will be appreciated that aspects of the illustrated process 300 are to be understood as non-limiting examples, and that further methods of managing event ticket allocation and purchases different than that specifically illustrated in FIG. 3 may also incorporate inventive aspects of the disclosed embodiments.

As illustrated, a user may be presented with a landing screen associated with an event ticketing management service (e.g., via a webpage and/or an application associated with the service). The user may login to the event ticketing management service by presenting associated credentials (e.g., a username, password, and/or the like). In some embodiments, logging in to the event ticketing management service may also result in a login to one or more music streaming services, allowing access to certain APIs associated with the music streaming services. Via these exposed APIs, the event ticketing management service may receive analytics data consistent with various described embodiments relating to the user and/or their preferred top artists. For example and without limitation, in certain embodiments, the event ticketing management service may access a list of the top preferred artists associated with the logged in user as reflected in the analytics data received from the music services and present the user with a page listing these artists. An interface showing the user's list of top preferred artists may be presented by the event ticketing management service to the user on their associated device.

The user may select an artist from the listed preferred artists and view whether the artist has any associated upcoming live events with available tickets offered to their preferred fans. The user may select an available event and, if tickets remain available, may utilize ticketing service interfaces and/or associated processes to purchase tickets to the event at the face value set by the artist. Upon a successful purchase, a confirmation message may be sent to the user by the event ticketing management service. Tickets may be delivered to the user in a variety of ways, including electronically through an application (e.g., through a ticketing service application and/or the like) and/or through any other suitable electronic communication method.

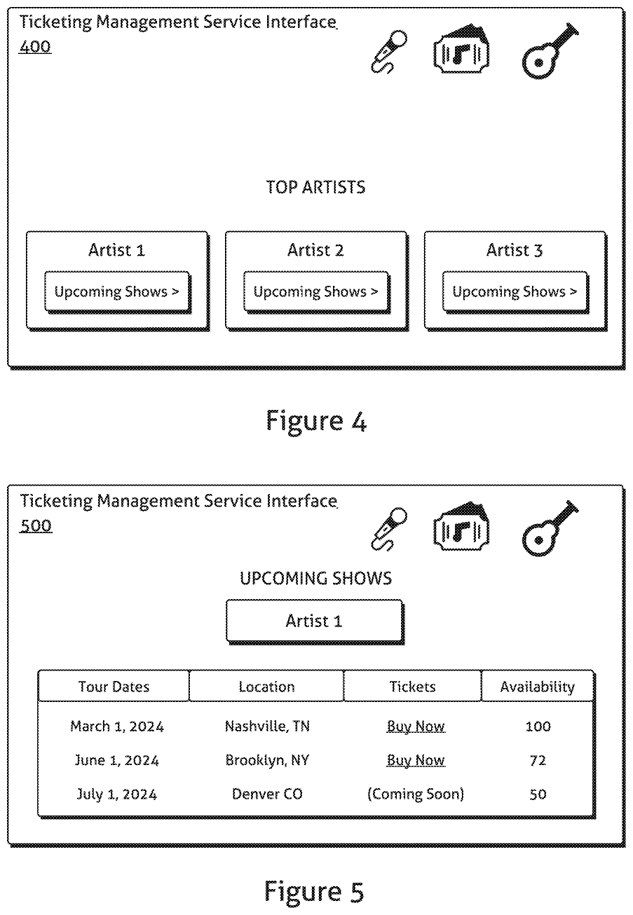

FIG. 4 illustrates a non-limiting example of a preferred artists 400 interface of a ticket management service consistent with certain embodiments of the present disclosure. As shown in the example interface, upon logging into a ticket management service, a user may be presented with a listing of their preferred artists, as determined by the service based on analytics data received from one or more music services. A user may select an artist from the list of preferred artists to view upcoming events associated with the artist, which may have tickets available for immediate purchase and/or may be available for purchase in the future.

FIG. 5 illustrates a non-limiting example of an artist event availability interface 500 of a ticket management service consistent with certain embodiments of the present disclosure.

After selecting an artist from a list of preferred artists, a user may be presented with a listing of upcoming events associated with the artists. This list may include, for example and without limitation, event date(s), location(s), and ticket availability, which may include both an indication of whether tickets are currently available for purchase and/or how many tickets have been allocated by the artist to their top fans. A user may select a desired event via the interface and, if tickets are available, they may proceed to an interface and/or series of interfaces to purchase tickets to the event.

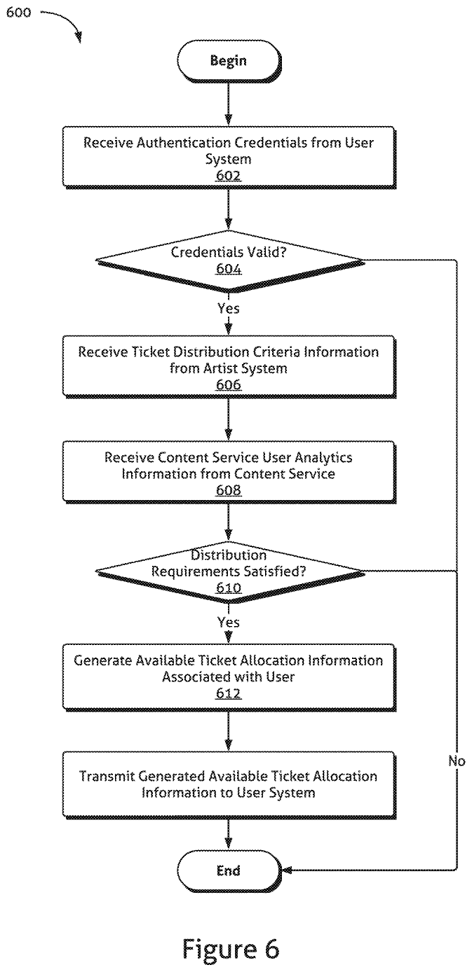

FIG. 6 illustrates a flow chart of a non-limiting example of a method for managing ticket distribution consistent with certain embodiments of the present disclosure. The illustrated method 600 and/or aspects thereof may be implemented in a variety of ways, including using software, firmware, hardware, and/or any combination thereof. In certain embodiments, various aspects of the method 600 and/or its constituent steps may be performed by an event ticketing management service, one or more content services, an artist system, a user system and/or device, and/or any other suitable system and/or services or combination of systems and/or services.

At 602, authentication credentials (e.g., a username, password, etc.) may be received by an event ticketing management service from a user system. In various embodiments, the authentication credentials may comprise identification information associated with a user of the system. In some embodiments, the authentication credentials may be unique to the event ticketing management service. In further embodiments, the authentication credentials may be shared with another service such as, for example and without limitation, third-party ticketing platform services and/or content services (e.g., streaming services).

The received authentication credentials may be validated and/or otherwise authenticated at 604. In some embodiments, the event ticketing management service may validate the credentials independently. In further embodiments, the event ticketing management service may interact with one or more separate validation services and/or other services to validate the credentials (e.g., third-party ticketing platform services and/or content services). In some embodiments, a location of a user may be identified based on the authentication credentials (as part of and/or separate from the validation and/or authentication process), which may be used in connection with the enforcement of geographic-related ticket distribution requirements as detailed herein.

At 606, ticket distribution criteria information may be received from an artist system associated with an artist, potential in response to a request issued by the event ticketing management service. Consistent with embodiments disclosed herein, the ticket distribution criteria information may comprise a variety of information. For example and without limitation, the ticket distribution criteria information may comprise one or more of event identification information associated with an event, a ticket allocation quantity associated with the event, identification information associated with at least one content service, one or more ticket distribution requirements for the event associated with the at least one content service, and/or the like.

A variety of ticket distribution requirements may be used in connection with the disclosed systems and methods and/or otherwise enforced by the event ticketing management service. For example and without limitation, the ticket distribution requirements may comprise an indication of a specified total number of tickets allocated for the event, a per user specific ticket allocation (e.g., 2 tickets per user and/or the like), which may or may not be user specific, an indication of a threshold ranking of user listening frequency with a content service, an indication of a threshold listening frequency, duration, recency, etc., geographic area related requirements, and/or the like.

Content service analytics information associated with the user may be received from one or more content service systems at 608. In various embodiments, the content service systems may be associated with a music streaming and/or music download content service, although other types of content service systems are also envisaged. In some embodiments, the analytics information may be received in response to an analytics information request issued by the event ticketing management service to the content service for analytics information associated with the user identification information (e.g., transmitted to the content service using the identification information associated with the content service). For example and without limitation, the identification information associated with the content service may identify an exposed API of the content service, and the analytics information request may be issued to the content service via the exposed API.

At 610, it may be determined that the user satisfies the one or more ticket distribution requirements for the event based on the received content service analytics information. Based on determining that the user satisfies the one or more ticket distribution requirements for the event, available ticket allocation information associated with the user for the event may be generated at 612 and transmitted to the user system at 614. The user may engage in various transactions in connection with purchasing ticket(s) based on the transmitted available ticket allocation information.

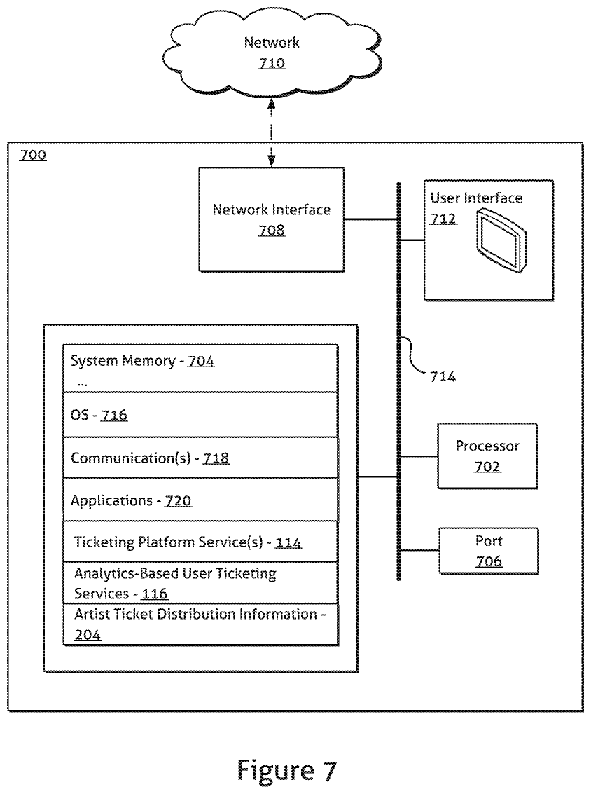

FIG. 7 illustrates an example of a system 700 that may be used to implement certain embodiments of the systems and methods of the present disclosure. Certain elements associated with the illustrated system 700, but not necessarily all, may be included in an event ticketing management service system, a music service system, a user device, and/or any other device, system, and/or service configured to implement the embodiments of the systems and methods disclosed herein and/or various aspects thereof.

As illustrated in FIG. 7, the system 700 may include: a processing unit 702; system memory 704, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 702; a port 706 for interfacing with removable and/or integrated memory and/or other devices such as, for example and without limitation, a USB port); a network interface 708 for communicating with other systems via one or more network connections 710 using one or more communication technologies; a user interface 712 that may include a display, one or more input/output devices such as, for example, a touchscreen, a display, a monitor, a keyboard, an input stylus, a mouse, a track pad, and the like; and one or more busses 714 for communicatively coupling the elements of the system 700.

The operation of the system 700 may be generally controlled by one or more processing units 702 (which can be general purpose CPUs or specific, even purpose-built processors, such as a digital signal processor) that execute software instructions and programs stored in the system memory 704 and/or internal memory of the processing units 702. The system memory 702 may store a variety of executable programs or modules for controlling the operation of the system. For example, the system memory 702 may include an operating system (“OS”) 716 that may manage and coordinate, at least in part, system hardware resources and provide for common services for execution of various applications, modules, and/or services. The system memory 704 may further include, for example and without limitation, communication software 718 configured to enable in part communication with and by the system; one or more applications 720; ticketing platform service modules 114, analytics-based user ticketing services 116, artist ticket distribution criteria information 204, and/or any other information, executable modules, and/or applications configured to implement embodiments of the systems and methods disclosed herein.

The systems and methods disclosed herein are not limited to any specific computer, device, service, or other apparatus architecture and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including all forms of compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and data, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It is noted that there are many alternative ways of implementing both the devices and methods described herein. Accordingly, the present embodiments are to be considered as illustrative and not restrictive, and the invention is not to be limited to the details given herein but may be modified within the scope and equivalents of the disclosed embodiments and the appended claims.

1. A computer-implemented method for managing ticket distribution performed by an event ticketing management service system, the method comprising:
receiving authentication credentials from a user system, the authentication credentials comprising identification information associated with a user of the user system;
validating the authentication credentials received from the user system;
receiving, from an artist system associated with an artist, ticket distribution criteria information, the ticket distribution criteria information comprising event identification information associated with an event, a ticket allocation quantity associated with the event, identification information associated with at least one content service, and one or more ticket distribution requirements for the event associated with the at least one content service;
accessing, using an exposed application program interface of a content service system associated with the at least one content service, content service analytics information associated with the user;
determining, based on the content service analytics information, that the user satisfies the one or more ticket distribution requirements for the event; “generating, based on determining that the user satisfies the one or more ticket distribution requirements for the event, available ticket allocation information configured to cause the user system to present a purchase interface for one or more tickets from the ticket allocation quantity associated with the event; and
transmitting, to the user system, the available ticket allocation information.

2. The method of claim 1, further comprising transmitting, to the content service system associated with the at least one content service and based on the identification information associated with the at least one content service, an analytics information request for analytics information associated with the identification information associated with the user.

3. The method of claim 2, wherein the content service analytics information is received in response to the analytics information request.

4. The method of claim 1, wherein receiving the content service analytics information comprises receiving, from the content service system, a listing of the plurality of top fans of the artist.

5. The method of claim 1, wherein the at least one content service comprises at least one music streaming service.

6. The method of claim 1, wherein the at least one content service comprises at least one music download service.

7. The method of claim 1, wherein validating the authentication credentials received from the user system comprises validating the authentication credentials received from the user system with the content service system.

8. The method of claim 1, wherein the one or more ticket distribution requirements for the event associated with the at least one content service comprise an indication of a specified total ticket allocation number for the event.

9. The method of claim 1, where the one or more ticket distribution requirements for the event associated with the at least one content service comprise an indication of a specified ticket allocation for the user.

10. The method of claim 1, wherein the one or more ticket distribution requirements comprise an indication of a threshold ranking of user listening frequency with the at least one content service.

11. The method of claim 10, wherein determining that the user satisfies the one or more ticket distribution requirements for the event comprises determining that user of the user system is within the threshold ranking of user listening frequency with the content service.

12. The method of claim 1, wherein the one or more ticket distribution requirements comprise an indication of a geographic area associated with the event.

13. The method of claim 12, wherein determining that the user satisfies the one or more ticket distribution requirements for the event comprises determining that user is associated with a location within the geographic area.

14. The method of claim 13, wherein method further comprises identifying the location associated with the user based on the validation of the authentication credentials received from the user system.

15. The method of claim 1, wherein the method further comprises transmitting a request to the artist system for ticket distribution criteria information.

16. The method of claim 15, wherein the receiving the content service analytics information is responsive to the request.

17. The method of claim 1, wherein the content service analytics information comprises raw analytics metrics comprising at least one of a number of listening hours, a number of tracks listened to, or a number of albums accessed.

18. The method of claim 1, wherein the content service analytics information is indicative of an inference of artist preference generated by the content service system.
